(19) United States
(12) Patent Application Publication
(10) Pub. No.: US 2008/0020106 A1
(43) Pub. Date: Jan. 24, 2008

(54) COMESTIBLE WRAP PRODUCT AND METHOD OF MAKING THE SAME

(75) Inventors: Lois Carson, Lake Forest, CA (US); Michelle Goncalves, San Marcos, CA (US); Nancy Cutler, Tustin, CA (US)

Correspondence Address: KNOBBE MARTENS OLSON & BEAR LLP, 2040 MAIN STREET, FOURTEENTH FLOOR, IRVINE, CA, 92614, US

(73) Assignee: Taco Bell Corporation, Irvine, CA (US)

(21) Appl. No.: 11/866,864

(22) Filed: Oct. 3, 2007

Related U.S. Application Data
(63) Continuation of application No. 11/315,765, filed on Dec. 22, 2005.
(60) Provisional application No. 60/639,042, filed on Dec. 23, 2004.
(60) Provisional application No. 60/651,148, filed on Feb. 9, 2005.

(51) Int. Cl. A21D 13/00

(52) U.S. Cl. 426/138

(57) ABSTRACT

A comestible wrap product comprising a relatively rigid backbone and a flexible outer skin is provided along with a method for making the same. The flexible outer skin is wrapped around the relatively rigid backbone and one or more additional ingredients. The flexible skin is grilled to resist unfolding and holds together rigid backbone and any additional ingredients.

### CROSS-REFERENCE TO RELATED APPLICATIONS

This application is a continuation application of U.S. application Ser. No. 11/315,765, filed Dec. 22, 2005, which claims priority to U.S. Provisional Application No. 60/639,042, filed Dec. 23, 2004 and to U.S. Provisional Application No. 60/651,148, filed Feb. 9, 2005. The entire contents of these three applications are hereby incorporated by reference herein.

### BACKGROUND OF THE INVENTION

1. Field of the Invention

The invention relates to food products and methods for preparing food products.

2. Description of the Related Art

Mexican restaurants often serve a food item called a tostada. A tostada is generally a crisp corn tortilla shell topped with ingredients such as beans, sauce, lettuce, and cheese. Although the tostada is a popular item, it has several drawbacks particularly for Mexican restaurants that offer quick service or take-out food prepared for customers to take with them to eat at another location. The tostada's drawbacks are particularly problematic for customers buying food at drive-through windows since those customers often buy food to eat in their cars.

The traditional tostada is not an easily portable food item. The beans, sauce, lettuce, and cheese rest on a flat tortilla shell. Therefore, the beans, sauce, lettuce, and cheese are vulnerable to sliding off the tortilla shell and/or to getting wiped off the tortilla shell by a bag, a clothing item such as a customer's sleeve, or by some other object. The traditional tostada can be messy to eat. Customers eating traditional tostadas are generally forced either to use eating utensils or to contend with beans and cheese on their fingers.

Another drawback of the traditional tostada is that the hot ingredients such as the beans are mixed with the cold ingredients such as the lettuce. Thus, if the tostada is not eaten promptly after it is assembled the heat transfer from the hot ingredients to the cold ingredients decreases the quality of the product. The hot items cool down more quickly, and the cold ingredients heat up and loose their crispness.

A comestible wrap food product consistent with one or more aspects of this invention includes the benefits of the popular tostada taste without the drawbacks of the traditional tostada associated with portability and freshness.

### SUMMARY OF THE INVENTION

In accordance with one embodiment, the present invention provides a comestible wrap product comprising a relatively rigid, crunchy member providing a structure for the wrap; one or more ingredients disposed adjacent to the crunchy member; and a flexible outer skin folded around the crunchy member so as to completely enclose the crunchy member and the one or more ingredients, the flexible outer skin including a plurality of folds on one side of the crunchy member, each fold being grilled such that the outer skin resists unfolding and holds the crunchy member and one or more additional ingredients inside. In some embodiments, the flexible outer skin is folded along six lines.

In some embodiments, a first side section of the flexible outer skin is folded toward the center of the wrap; a second side section of the flexible outer skin is folded toward the center of the wrap; and each remaining side section of the flexible outer skin is folded toward the center of the wrap until no side section remains unfolded. In one embodiment, each consecutive side section selected for folding is adjacent to the side section previously folded. In one embodiment, six side sections of the flexible outer skin are folded toward the center of the wrap. Also, in one embodiment, the perimeter of the wrap has a generally hexagonal shape.

In some embodiments, the crunchy member may comprise a deep fried corn tortilla. Also in some embodiments, the flexible outer skin may comprise a flour tortilla. In some embodiments, both a folded side and an unfolded side of the outer skin are grilled.

In accordance with another embodiment, the present invention provides a comestible wrap product comprising: a relatively rigid structural base wherein the structural base has a first side and a second side; at least one hot ingredient in contact with the first side of the structural base; at least one cold ingredient in contact with the second side of the structural base; and a flexible outer skin that holds together the structural base and the hot and cold ingredients. In some embodiments, the structural base may comprise a deep fried corn tortilla. In some embodiments, the flexible outer skin may comprise a flour tortilla. In some embodiments, the flexible outer skin is folded around the structural base, the one or more hot ingredients, and the one or more cold ingredients. In some embodiments, the flexible outer skin comprises folds along six lines. Also, in some embodiments, the perimeter of the wrap has a generally hexagonal shape. In some embodiments, the wrap is grilled.

In accordance with one application, the present invention provides a method of preparing a comestible wrap product comprising: folding a flexible outer skin member around a relatively rigid, crunchy member and around one or more additional ingredients such that the outer skin member holds together the crunchy member and the one or more additional ingredients; and heating the outer skin layer so that it resists unfolding. In some applications, the heating step comprises grilling at least one side of the wrap. Also, in some applications, the method comprises placing one or more hot ingredients on a first side of the rigid base and placing one or more cold ingredients on a second side of the rigid base.

In some applications folding the outer skin member comprises making six folds. Also in some applications, folding the outer skin member comprises: folding a first side section of the outer skin member toward the center of the wrap; folding a second side section of the outer skin member toward the center of the wrap; and folding each remaining side section of the outer skin member one at a time toward the center of the wrap until no side is left unfolded. Also, in some applications of the method, each consecutive side section selected for folding is adjacent to the side previously folded. In one application, six sides section of the outer skin are folded toward the center of the wrap. In some applications, heating the wrap product comprises grilling.

Another aspect of the present invention involves a food product comprising one or more relatively rigid backbones or substrates with at least one comestible element on each side of the relatively rigid backbone. An outer skin layer is folded around the relatively rigid backbone. The outer skin layer also surrounds the comestible elements on both sides of the relatively rigid backbone and holds all of the elements together. The outer skin can be grilled or ungrilled.

A method of preparing a food product consistent with this invention begins with the outer skin layer. At least one comestible food element is placed near the center of an upward facing surface of the outer skin layer. The relatively rigid backbone is then placed on top of the at least one comestible food element. Next, at least one additional comestible food element is place on top of the relatively rigid backbone. The outer skin layer is folded around the relatively rigid backbone so as to generally cover the comestible food elements on both sides of the backbone.

In one assembly mode, a first side section of the outer skin layer can be folded by bringing an edge of the outer skin layer towards the center with the outer skin pulled generally taut against the backbone. Then a second side section of the outer skin layer is folded towards the center, with the skin again being taut against the backbone. The second side section of the skin preferably is adjacent to the first side section. Each consecutive side section of the outer skin layer is folded until no unfolded sides remain. The folded product can then be grilled to help the folds adhere to each other and stay in place or, in another embodiment, the comestible food elements can be used to help the folds adhere to each other.

In one embodiment, the relatively rigid backbone or substrate that serves as a base layer may comprise a tostada shell or fried corn tortilla. A soft flour tortilla may serve as the outer skin layer. A layer of meat and/or beans can be placed on top of the outer skin layer. A layer of cheese may be placed on top of the layer of meat and/or beans. Then the relatively rigid backbone layer, a tostada shell, is placed on top of the layer of cheese. A layer of sour cream may be placed on top of the relatively rigid backbone layer. Vegetables such as lettuce and tomatoes may be placed on top of the relatively rigid backbone layer as well. The soft flour tortilla is then folded around the other ingredients using the tostada shell as a base for the folds.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely examples and are not intended to limit the invention. The following are brief descriptions of the drawings.

FIG. 1 is a perspective view showing the top and portions of the sides of one embodiment of a comestible wrap product consistent with this invention.

FIG. 2 is a plan view showing the top of the wrap of FIG. 1.

FIG. 3 is a plan view showing the bottom of the wrap of FIG. 1.

FIG. 4 is an elevation view showing the wrap of FIG. 1 from one of its sides.

FIG. 5 is an elevation view showing the wrap of FIG. 1 from a point in between two of its sides.

FIG. 6 is an elevation view showing the wrap of FIG. 1 from a different point between another two sides.

FIG. 7 is an elevation view showing the wrap of FIG. 1 from another one of its sides.

FIG. 8 illustrates a cross section view of the wrap of FIG. 1 taken alone line 8-8.

FIG. 9 illustrates a step in one application of the method for preparing one embodiment of a comestible wrap product consistent with this invention.

FIG. 10 illustrates the first step in folding the outside skin layer of one embodiment of a comestible wrap product consistent with this invention.

FIG. 11 illustrates the second step in folding the outside skin layer of one embodiment of a comestible wrap product consistent with this invention.

### DETAILED DESCRIPTION OF THE PREFERRED EMBODIMENT

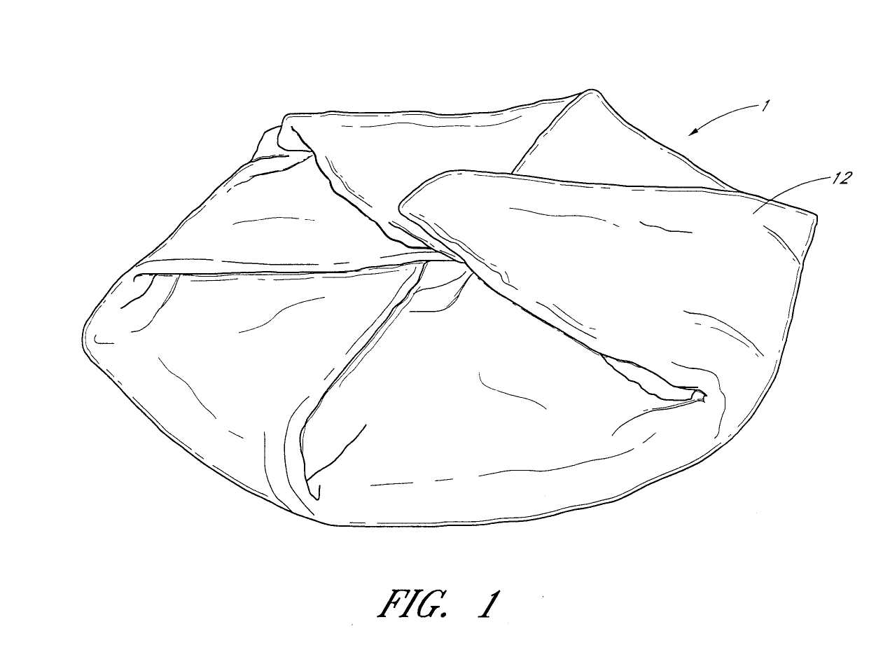

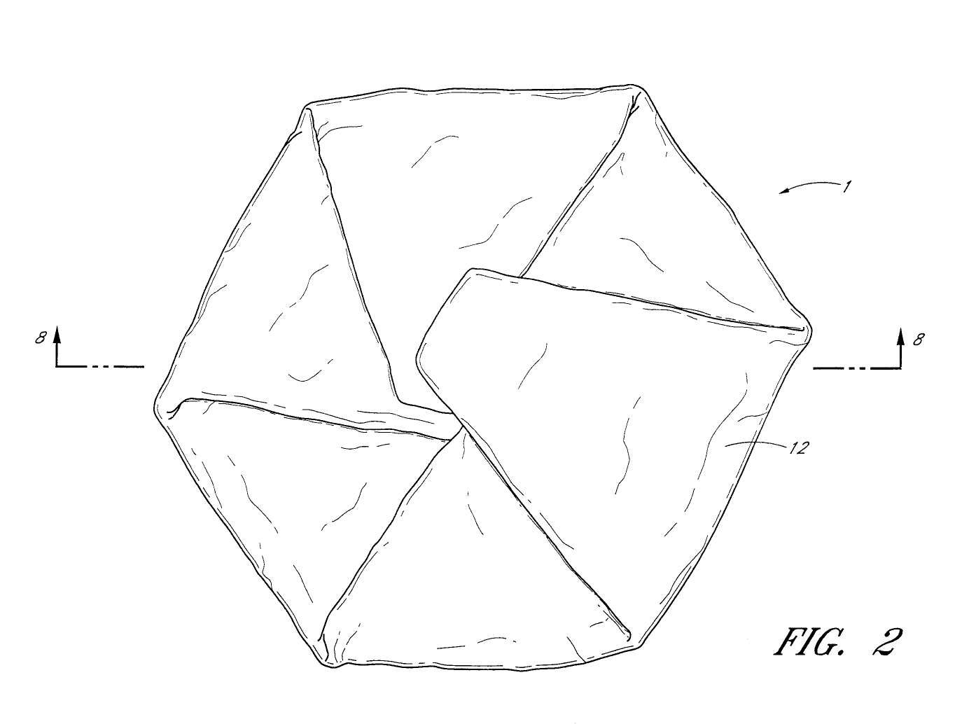

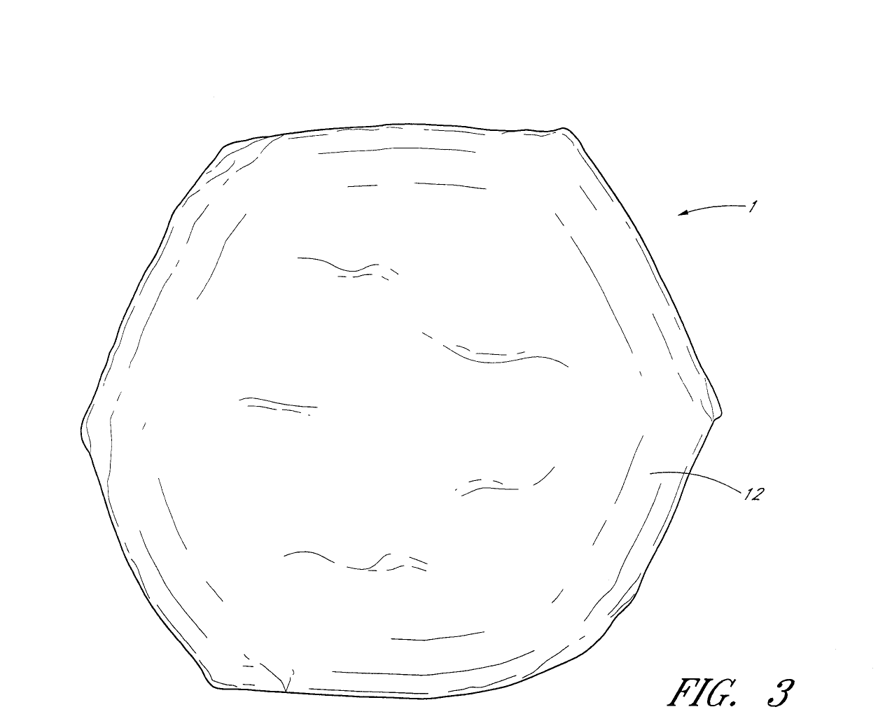

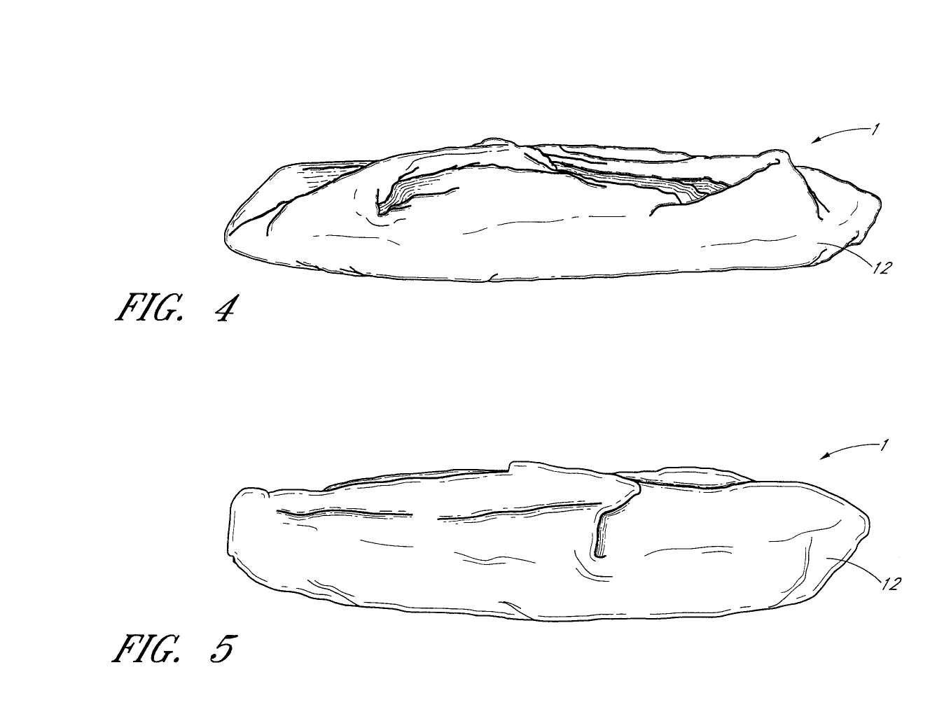

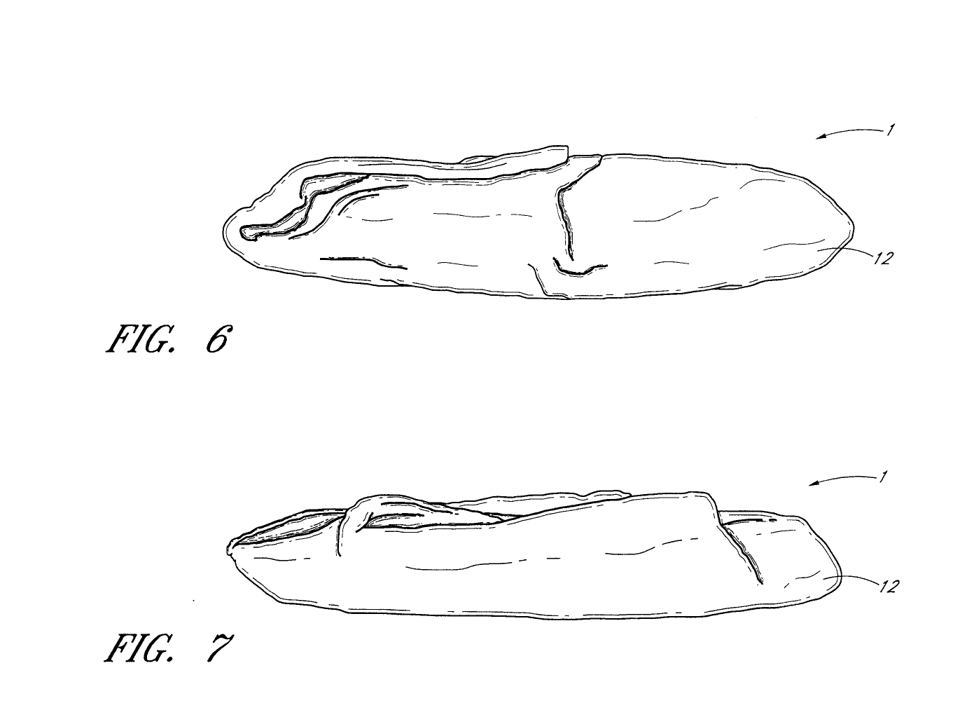

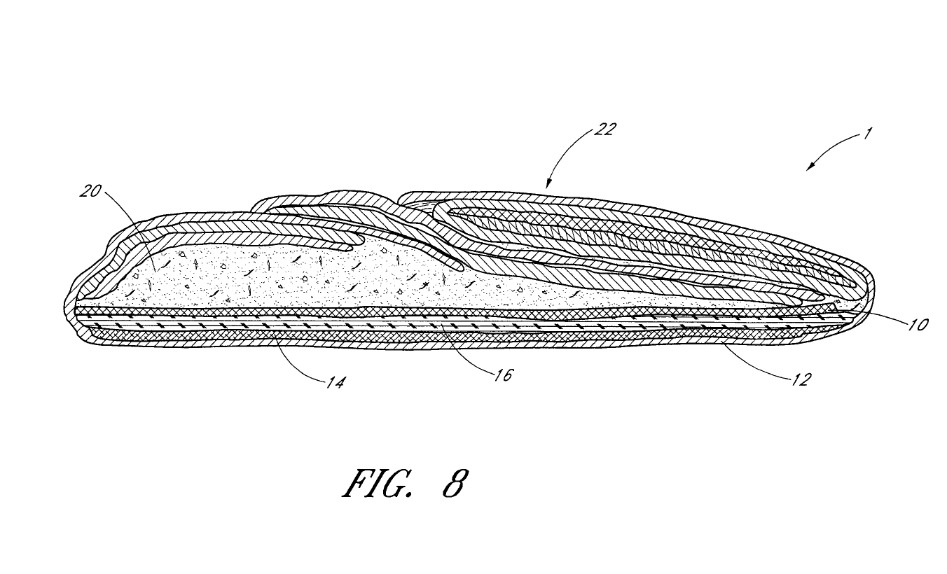

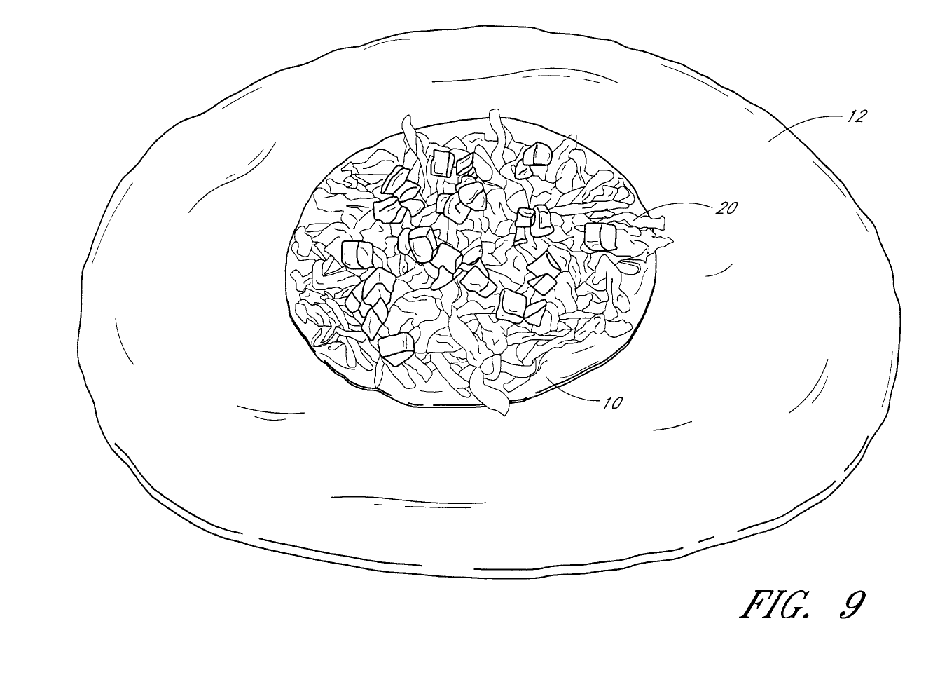

With reference to FIGS. 1-8, an embodiment of a comestible wrap product 1 is shown having certain features and advantages in accordance with the present invention. As shown in FIG. 8, an inner base of the wrap is a relatively rigid backbone or substrate 10 that provides support and helps define a shape for the wrap. In the embodiment shown, the relatively rigid backbone or substrate 10 has a circular shape; however, in other embodiments the backbone 10 may have other shapes (e.g. triangle, oval, octagonal, etc.) The relatively rigid backbone also provides the wrap 1 with a crunchy or crispy texture that appeals to consumers. In the embodiment shown in FIG. 8, the relatively rigid backbone 10 comprises a tostada shell or a deep-fried corn tortilla. These are just examples of comestibles that are more rigid than an outer skin 12 of the wrap. It is understood that other relatively rigid comestibles can be used in other applications having some or all of the aspects and features of the present wrap. Such other relatively rigid comestibles include, without limitation, crackers, dried or fried meal-based products, dried or fried bread products, dried or fried potato-based products, and the like.

As can be seen in FIGS. 1-7, the outside of the wrap 1 is defined by the outer skin 12, which comprises a soft wrap layer. The outer skin layer 12 is folded about the relatively rigid backbone 10. The outer skin layer 12 also surrounds the other elements and holds all of the elements together. The outer skin layer 12 makes the wrap 1 an easily portable food item since it is easier to transport and easier to eat a food item that is self contained. The outer skin layer 12 inhibits the messier ingredients inside from spilling.

In the embodiment shown in FIG. 8, the outer skin layer 12 can be seen at the bottom of the wrap 1. A layer of hot ingredients 14, such as meat or beans, can be placed just on top of the outer skin 12. A cheese layer 16 is preferably placed on top of the hot ingredient layer 14. The cheese 16 preferably is a melted nacho-type cheese or other cheese-like sauce, but grated cheese can also be used in the wrap. The relatively rigid backbone 10 rests on top of the cheese layer 16. A sour cream layer can be placed on top of the relatively rigid backbone. Cool ingredients 20 may also be added on top of the relatively rigid backbone 10. For example, a layer of shredded lettuce can be placed on top of the sour cream layer, and a layer of chopped tomatoes can be placed on top of the lettuce layer. The folds 22 of the outer skin layer 12 are shown at the top of the wrap.

In the embodiment shown in FIG. 8, the relatively rigid backbone 10 separates the hot ingredients 14, such as meat or beans from the cool ingredients 20, such as lettuce and tomatoes. This arrangement generally keeps the hot ingredients 14 from losing their heat and the cool ingredients 20 from warming up. The wrap then retains freshness even when a consumer does not eat it immediately after it is made.

In alternate embodiments of a comestible wrap product consistent with this invention, the ingredients may vary and the order of the layers of ingredients may vary. For instance, in one embodiment additional ingredients such as hot sauce or peppers may be added. In another embodiment the hot ingredients 14 may be mixed with the cool ingredients 20 so that all of the ingredients are on one side of the relatively rigid backbone 10. In yet another embodiment, the wrap may be made without the cool ingredients 20, and in still another embodiment the wrap may be made without the hot ingredients 14. Additionally, the wrap can include two or more relatively rigid backbones that can be of the same shape, texture, and taste and formed of the same material. Alternatively, the two or more backbones can be different.

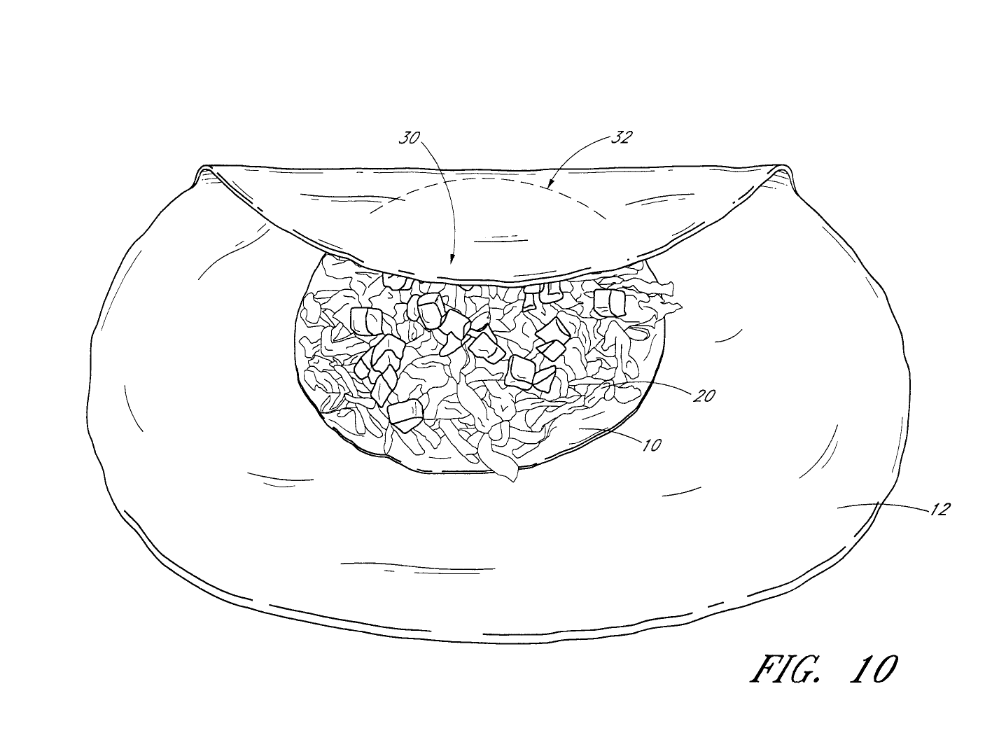

FIGS. 9-11 illustrate one application of the method for preparing the tostada wrap 1 illustrated by FIGS. 1-8. With reference to FIG. 9, the preparation of the wrap begins with the outer skin 12. In the embodiment shown in FIG. 9, the outer skin 12 is a soft flour tortilla. The person preparing the wrap preferably places the hot ingredients 14 such as beans and/or meat (for example ground beef) near the center of the upward facing surface of the outer skin 12. A cheese layer 16 may be added on top of the hot ingredients 14. Next, as shown in FIG. 9, the relatively rigid backbone 10, in this case a tostada shell, is placed on top of the hot ingredients 14 and/or cheese layer 16. Sour cream may be added on top of the tostada shell. With reference to FIG. 9, cool ingredients 20 such as shredded lettuce may be added on top of the sour cream. Another example of a cool ingredient 20, that may be added is chopped tomatoes.

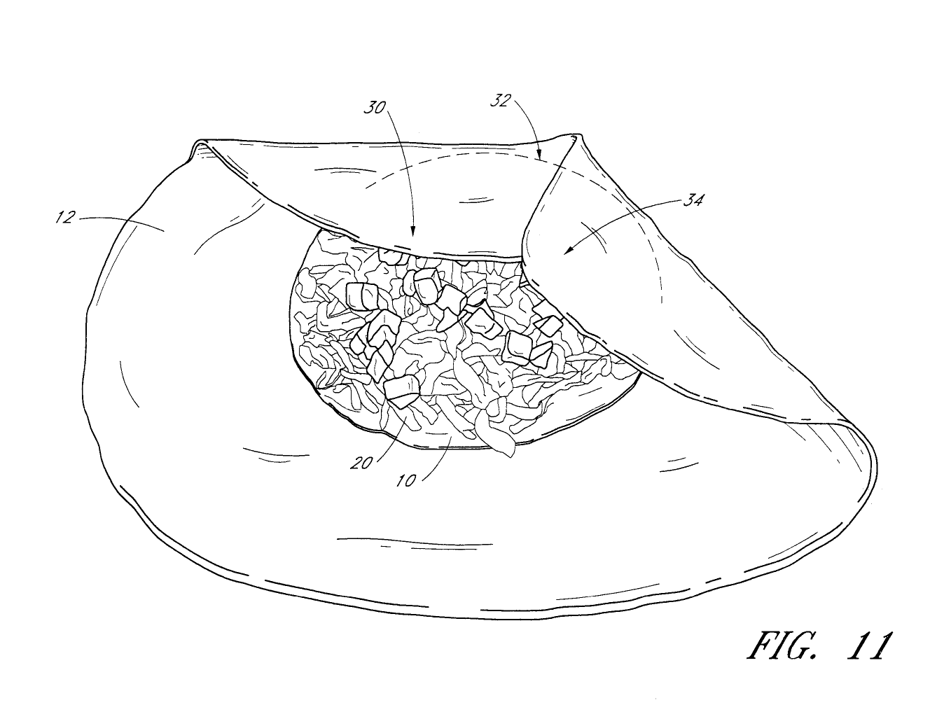

As shown in FIGS. 10-11, the next step in preparing the wrap is folding the outer skin 12. With reference to FIG. 10, a first side section 30 of the outer skin layer 12 in this case the soft tortilla, is folded by bringing the edge of the outer skin layer 12 towards the center of the wrap, with the outer skin 12 pulled generally taught against the backbone 10. The relatively rigid backbone 10 provides a guide for folding the outer skin layer 12 such that the fold in the outer skin layer 12 is made at the edge 32 of the relatively rigid backbone 10, in this case the tostada shell. Next, as shown in FIG. 11, a second side section 34 of the outer skin layer 12 is folded towards the center of the wrap and pulled generally taught against the tostada shell. The second side section 34 of the outer skin preferably is adjacent to the first side section 30. Again, the relatively rigid backbone 10 is used as a guide folding the outer skin layer 12, and the fold is made at the edge 32 of the relatively rigid backbone 10. The remaining sides of the outer skin layer 12 are each folded one at a time towards the center of the wrap until no sides of the outer skin layer 12 are left unfolded. FIG. 1 depicts the outer skin layer 12 enclosing the other ingredients after folding has been completed. Each of the folds is made at the edge of the relatively rigid backbone 10.

FIGS. 1-8 show one embodiment of a comestible wrap product 1 consistent with this invention where a total of six folds are made in the outer skin layer 12. The end result is a wrap 1 having a perimeter that is the shape of a hexagon. Although the embodiment shown has a circle shaped backbone 10 and six folds are made in the skin 12, sore or less than six folds can be used with a circle shaped backbone 10. The total number of folds in the outer skin layer 12 can vary in different embodiments of the wrap. For example, one embodiment of the wrap has three folds in its outer skin layer and has a triangular shaped perimeter. Another embodiment has four folds in its outer skin layer and has a square shaped perimeter. Yet another embodiment has eight folds in its outer skin layer and has an octagonal shaped perimeter. Any number of folds can be used.

The final step in preparing the wrap is heating it. The folded wrap preferably is placed folded side down on a hot pan or grill. The wrap preferably is cooked folded side down on the grill until the folded side has generally reached a caramel color. The opposite side, the flat side of the wrap, can either be cooked simultaneously or subsequently. For example, the wrap can be grilled on a grill press which will grill both sides of the wrap at the same time. Alternatively, the wrap can be flipped and the flat side can be cooked on the grill until it has generally reached a caramel color. The heating step helps the folded sides of the outer skin 12 to stick together so that the wrap's outer skin 12 tends to stay folded. In different embodiments of the wrap, the method of cooking the wrap may vary. For example, only the folded side of the wrap is grilled in some embodiments.

In the embodiment shown in FIGS. 1-8, the soft outer skin layer 12 is large enough relative to the backbone 10 that the folded edges of the soft outer skin layer 12 meet or overlap in the center of the wrap 1. However, partial closure is acceptable. In some embodiments, the soft outer skin layer 12 may not be large enough relative to the backbone 10 to have its folded edges meet in the middle. Thus, a space may separate the folded up edges of the outer skin layer 12 at the center of the wrap 1. The space, however, preferably is sufficiently small to inhibit the inner ingredients from spilling out the space.

The wrap can be served to a customer using any of a number of different presentation or packaging methods. For example, the wrap can be served on a tray, preferably for consumers who intend to eat the wrap at the restaurant where they purchase the wrap, or the wrap can be served in a clam-shell type box, preferably for consumers who take the wrap out of the restaurant. The wrap can also be served on a tray with both the wrap and tray placed in a clam-shell type box. In yet another example, the wrap can be served in a pocket type package that encloses a portion of the wrap while the remainder of the wrap extends outside of the package. A consumer can hold the wrap within the pocket type package while eating the portion of the wrap that extends outside of the package making the wrap even easier and less messy to eat. A preformed pocket type package can be used or a packaging, material, for example foil or paper, can be folded around the wrap to form a pocket type package.

The wrap provides a portable food product that can include many popular ingredients while minimizing the difficulties often associated with transporting and eating food products containing those ingredients. Although the invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof.

1. A comestible wrap product comprising:
a relatively rigid backbone formed at least in part of meat and providing portion a structural for the wrap;
one or more ingredients disposed adjacent to the backbone; and
a flexible outer skin folded around the backbone so as to completely enclose the backbone and the one or more ingredients, the flexible outer skin including a plurality of folds on one side of the meat patty, each fold being grilled such that the outer skin resists unfolding and holds the backbone and one or more additional ingredients inside.

2. The wrap product of claim 1, wherein the flexible outer skin is folded along six lines.

3. The wrap product of claim 1, wherein
a first side section of the flexible outer skin is folded toward the center of the wrap;
a second side section of the flexible outer skin is folded toward the center of the wrap; and
each remaining side section of the flexible outer skin is folded toward the center of the wrap until no side section remains unfolded.

4. The wrap product of claim 1, wherein the meat is generally round and is cooked.

5. The wrap product of claim 1, wherein six side sections of the flexible outer skin are folded toward the center of the wrap.

6. The wrap product of claim 1, wherein the flexible outer skin comprises a flour tortilla.

7. A comestible wrap product comprising:
a portion of meat providing a structural backbone for the wrap;
one or more ingredients in contact with the portion of meat;
a flexible outer skin folded around the portion of meat and the one or more ingredients wherein the flexible outer skin is configured to resist unfolding and wherein
a first side section of the flexible outer skin is folded toward the center of the wrap;
a second side section of the flexible outer skin is folded toward the center of the wrap; and
each remaining side section of the flexible outer skin is folded toward the center of the wrap until no side section remains unfolded.

8. The wrap product of claim 7, wherein the portion of meat is generally round and is cooked.

9. The wrap product of claim 7, wherein the flexible outer skin comprises a flour tortilla.

10. The wrap product of claim 7, wherein the flexible outer skin comprises folds along six lines.

11. The wrap product of claim 7, wherein the perimeter of the wrap has a generally hexagonal shape.

12. The wrap product of claim 7, wherein the flexible outer skin is grilled to resist unfolding.

13. A method of preparing a comestible wrap product comprising:
folding a flexible outer skin member around a portion of meat formed into a round shape and around one or more additional ingredients such that the outer skin member holds together the portion of meat and the one or more additional ingredients, and
heating the skin layer so that it resists unfolding,
wherein folding the outer skin member comprises:
folding a first side section of the outer skin member toward the center of the wrap;
folding a second side section of the outer skin member toward the center of the wrap; and
folding each remaining side section of the outer skin member one at a time toward the center of the wrap until no side is left unfolded.

14. The method of claim 13, wherein the heating step comprises grilling at least one side of the wrap.

15. The method of claim 13, wherein folding the outer skin member further comprises making six folds.

16. The method of claim 13, wherein each consecutive side section selected for folding is adjacent to the side previously folded.
